(19) United States
(12) Patent Application Publication
(10) Pub. No.: US 2016/0369865 A1
(43) Pub. Date: Dec. 22, 2016

(54) Acoustical Absorber With Integral Fastener

(71) Applicant: FORD GLOBAL TECHNOLOGIES, LLC, Dearborn, MI (US)

(72) Inventors: Raghu Puttaiah, Troy, MI (US); Bryn Arthur Davies, Novi, MI (US)

(21) Appl. No.: 14/744,353

(22) Filed: Jun. 19, 2015

(51) Int. Cl. F16F 15/08; G10K 11/00

(52) U.S. Cl. CPC F16F 15/08; G10K 11/002

(57) ABSTRACT

An acoustical absorber is provided. That absorber includes a body incorporating an integral fastener. The integral fastener may take the form of a mounting aperture surrounded by a serrated margin of resilient teeth that provide a positive retention force for securing the acoustical absorber to a weld stud or other attachment point.

### TECHNICAL FIELD

This document relates generally to the motor vehicle equipment field and, more particularly, to an acoustical absorber, such as a shock tower insulator, that incorporates an integral fastener for securing the absorber in a proper operating position on the motor vehicle.

### BACKGROUND

Acoustical absorbers are employed in any number of applications on a motor vehicle in order to control noise, vibration and harshness (NVH). One such application is as a shock tower insulator.

In the past, engine compartment insulators, such as the shock tower insulator previously mentioned, may be secured in position on a threaded stud by cooperating washers and nuts or, for example, on weld studs by means of a Tinnerman clip. Any connection requiring separate fasteners, such as used in the prior art also requires tool clearance to allow the installation of the fastener used to hold the prior art insulator in position. This tool clearance represents a limitation on designers and often complicates vehicle design.

This document relates to a new and improved acoustical absorber and shock tower insulator incorporating an integral fastener thereby eliminating the need for designers to maintain a tool clearance and freeing up that space for other purposes. This is a particularly advantageous result in the engine compartment where a number of different acoustic absorbers and insulators are utilized and limited space makes space considerations a very important design factor.

### SUMMARY

In accordance with the purposes and benefits described herein, an acoustical absorber is provided. That acoustical absorber comprises a body incorporating an integral fastener. In one embodiment that integral faster comprises an aperture defined by a serrated margin.

In one possible embodiment, the serrated margin has a material density D₁ and the body adjacent the margin has a density D₂ where D₁ >D₂. Further, the acoustical absorber includes a reinforcing rib in the body that extends concentrically around the margin.

The margin may include a plurality of slits in communication with the aperture. Those slits define a plurality of resilient teeth. In one possible embodiment, the margin includes four spaced slits defining four resilient teeth. Each resilient tooth defines an equal arc of 90° of the aperture.

In one possible embodiment the body is made from a composite material such as a polyester fiber composite material.

In accordance with an additional aspect, a shock tower insulator is provided. That shock tower insulator comprises a body incorporating an integral fastener that secures the body to a mounting stud with a positive retention force. In one possible embodiment, the integral fastener comprises a mounting aperture surrounded by a serrated margin. That serrated margin may have a material density D₁ and the body adjacent the margin may have a density D₂ where D₁ >D₂.

Further, the shock tower insulator may include a reinforcing rib in the body extending concentrically around the margin. That margin may include a plurality of slits in communication with the aperture defining a plurality of teeth. In one possible embodiment, the margin includes four slits defining four resilient teeth where each of the resilient teeth defines an arc of 90° of the aperture. In one useful embodiment the positive retention force is at least 44 Newtons.

In the following description, there are shown and described several preferred embodiments of the acoustical absorber. As it should be realized, the acoustical absorber is capable of other, different embodiments and its several details are capable of modification in various, obvious aspects all without departing from the acoustical absorber as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the acoustical absorber and together with the description serve to explain certain principles thereof. In the drawing figures:

FIG. 1 is a top perspective view of an acoustical absorber, in the form of a shock tower insulator, constructed in accordance with the teachings of this document.

FIG. 2 is a bottom perspective view of the acoustical absorber/shock tower insulator illustrated in FIG. 1.

FIG. 3 is a detailed bottom plan view of one of the integral fasteners formed in the acoustical absorber/shock tower insulator showing the mounting aperture, serrated margin and surrounding reinforcing rib.

FIG. 4 is a cross-sectional view illustrating how the integral faster secures the acoustical absorber/shock tower insulator to a weld stud by providing a positive retention force.

Reference will now be made in detail to the present preferred embodiments of the acoustical absorber, examples of which are illustrated in the accompanying drawing figures.

### DETAILED DESCRIPTION

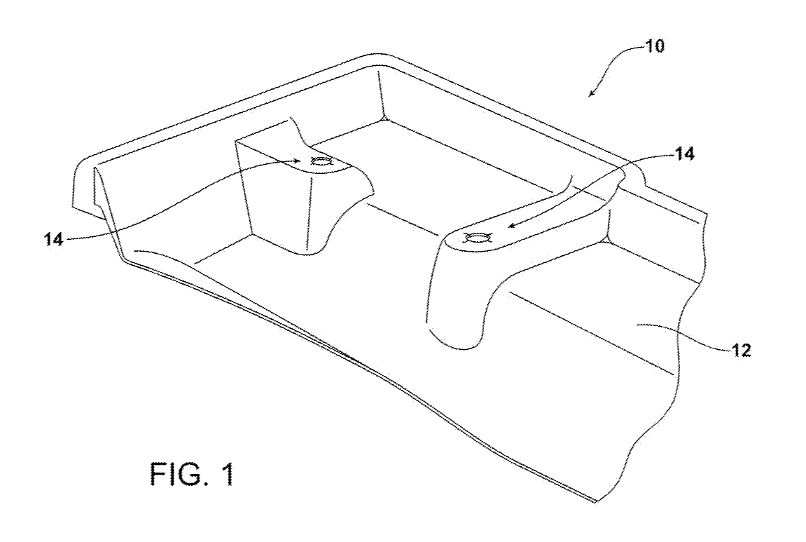

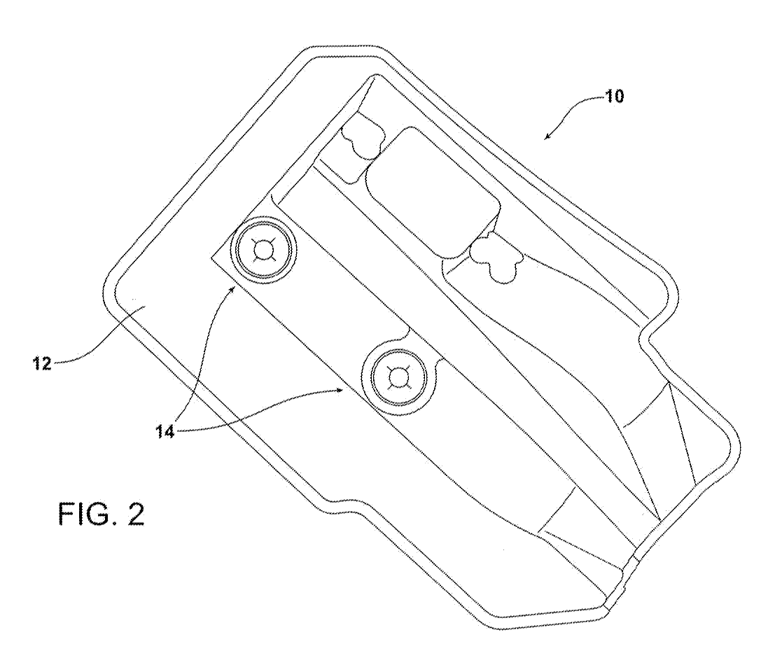

Reference is now made to FIGS. 1-4 illustrating the acoustical absorber 10 that is the subject matter of this document. In the illustrated embodiment, the acoustical absorber 10 comprises a shock tower insulator. It should be appreciated, however, that the shock tower insulator is just one possible embodiment/application of the acoustical absorber 10 and that the acoustical absorber should not be considered as being limited to a shock tower insulating application.

As illustrated, the acoustical absorber 10 comprises a body 12. That body 12 may be formed or molded from a composite material comprising, for example, a polymer matrix material and reinforcing fibers. In one useful embodiment, the acoustical absorber 10 may be made from polyester fiber composite material.

As illustrated in FIGS. 1-3, the body 12 incorporates at least one integral fastener, generally designated by reference number 14. Two integral fasteners 14 are provided in the body 12 in the illustrated acoustical absorber 10. It should be appreciated that the body could include substantially any number of integral fasteners from 1 to 4 or more.

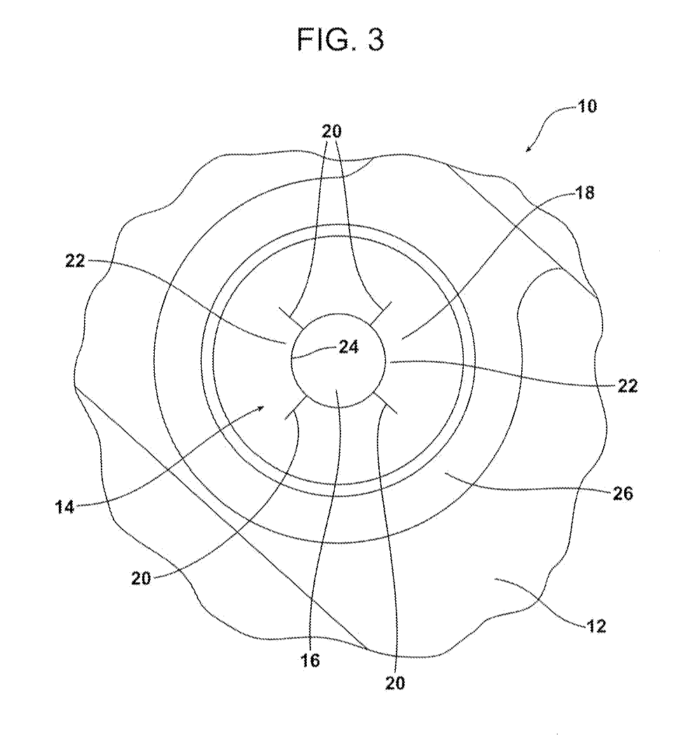

As best illustrated in detail in FIG. 3, each integral fastener 14 may comprise a mounting aperture 16 surrounded or concentrically received within and defined by a serrated margin 18.

The serrated margin 18 includes a plurality of slits 20 in communication with the mounting aperture 16. The serrated margin 18 includes a plurality of resilient teeth 22 defined between the slits 20. The distal or edge 24 of each tooth 22 is arcuate. In the illustrated embodiment, the serrated margin 18 includes four slits 20 forming four teeth 22. Each arcuate edge 24 defines an arc of 90° of the outer periphery of the mounting aperture 16.

As further illustrated in drawing FIGS. 1-3, the body 12 may also include a reinforcing rib 26 extending concentrically around the serrated margin 18. In one possible embodiment, the serrated margin 18 defined within the reinforcing rib 26 has a material density D₁ that is greater than the body 12 adjacent the serrated margin which has a density D₂. Together, the reinforcing rib 26 and increased material density D₁ add strength to the margin 18, including particularly the teeth 22, that increases the retention force provided to hold the acoustical absorber 10 in position.

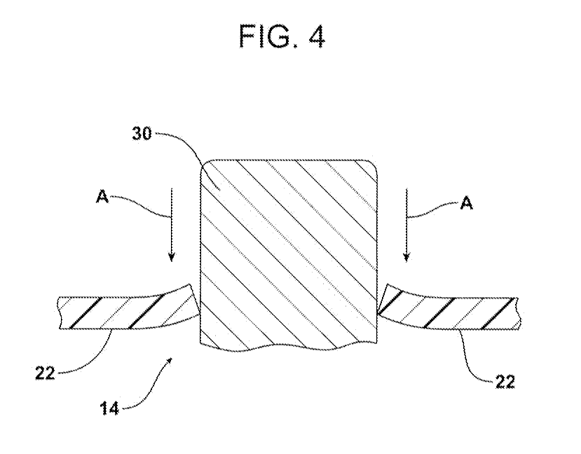

Reference is now made to FIG. 4 illustrating how the acoustical absorber 10 may be mounted onto a weld stud 30 by means of the integral fastener 14. This is done by positioning the acoustical absorber 10 over the weld stud 30 so that the mounting aperture 16 is aligned with the well stud. As should be appreciated, the weld stud 30 has a diameter that is slightly larger than the diameter of the mounting aperture 16.

The body 12 is then moved downwardly in the direction of action arrow A, forcing the serrated margin 18 over the weld stud 30. More specifically, the resilient teeth 22 are flexed slightly and provide a positive retention force for holding the acoustical absorber 10 on the weld stud 30 in the fully seated position for the acoustical absorber. That positive retention force may be on the order of at least 44 Newtons.

Numerous benefits are provided by the acoustical absorber 10. The acoustical absorber 10 incorporates an integral fastener 14 which eliminates the need for separate fasteners in many possible applications. This provides cost savings in materials, and assembly time is reduced. There is also no longer a need to maintain tool clearance for installing fasteners, allowing for more compact and less costly assemblies. This also frees designers to use the previously required clearance space for other, more useful purposes.

The foregoing has been presented for purposes of illustration and description. It is not intended to be exhaustive or to limit the embodiments to the precise form disclosed. Obvious modifications and variations are possible in light of the above teachings. While FIG. 4 shows the attachment of the acoustical absorber 10 to a weld stud 30 by means of the integral fastener 14, it should be appreciated that the integral fastener could also be used to engage and hold an attachment point other than a weld stud. All such modifications and variations are within the scope of the appended claims when interpreted in accordance with the breadth to which they are fairly, legally and equitably entitled.

1. An acoustical absorber, comprising:
a body incorporating an integral fastener.

2. The acoustical absorber of claim 1 wherein said integral fastener comprises an aperture defined by a serrated margin.

3. The acoustical absorber of claim 2, wherein said serrated margin has a material density D₁ and said body adjacent said serrated margin has a density D₂ where D₁ >D₂.

4. The acoustical absorber of claim 2, further including a reinforcing rib in said body extending concentrically around said margin.

5. The acoustical absorber of claim 4, wherein said margin includes four spaced slits defining four resilient teeth.

6. The acoustical absorber of claim 5, wherein each resilient tooth of said four resilient teeth define an equal arc of ninety degrees of said aperture.

7. The acoustical absorber of claim 4, wherein said margin includes a plurality of slits in communication with said aperture defining a plurality of resilient teeth.

8. The acoustical absorber of claim 7, wherein said body is made from a polyester fiber composite material.

9. A shock tower insulator, comprising:
a body incorporating an integral fastener that secures said body to a mounting stud with a positive retention force, wherein said positive retention force is at least 44 Newtons.

10. The shock tower insulator of claim 9, wherein said integral fastener comprises an aperture defined by a serrated margin.

11. The shock tower insulator of claim 10, wherein said serrated margin has a material density D₁ and said body adjacent said margin has a density D₂ where D₁ >D₂ .

12. The shock tower insulator of claim 10, further including a reinforcing rib in said body extending concentrically around said margin.

13. The shock tower insulator of claim 12, wherein said margin includes four spaced slits defining four resilient teeth.

14. The shock tower insulator of claim 13, wherein each resilient tooth of said four resilient teeth define an equal arc of ninety degrees of said aperture.

15. The shock tower insulator of claim 12, wherein said margin includes a plurality of slits in communication with said aperture defining a plurality of resilient teeth.

16. The shock tower insulator of claim 9, wherein said body is made from a polyester fiber material.

17. (canceled)
